(19) United States
(12) Patent Application Publication
(10) Pub. No.: US 2014/0001267 A1
(43) Pub. Date: Jan. 2, 2014

(54) INDICIA READING TERMINAL WITH NON-UNIFORM MAGNIFICATION

(71) Applicants: Patrick Anthony Giordano, Glassboro, NJ (US); Timothy Good, Clementon, NJ (US); Sean Philip Kearney, Marlton, NJ (US)

(72) Inventors: Patrick Anthony Giordano, Glassboro, NJ (US); Timothy Good, Clementon, NJ (US); Sean Philip Kearney, Marlton, NJ (US)

(73) Assignee: Honeywell International Inc. doing business as (d.b.a.) Honeywell Scanning & Mobility, Fort Mill, SC (US)

(21) Appl. No.: 13/538,380

(22) Filed: Jun. 29, 2012

(51) Int. Cl. G06K 7/14

(52) U.S. Cl. 235/462.41; 235/454; 235/470

(57) ABSTRACT

Embodiments of an indicia reading terminal have multiple fields of view (“FOV”). This feature allows decoding of decodable indicia that exhibit different characteristics. These characteristics may affect the ability of the terminal to identify and decode the information stored therein. In one embodiment, the terminal comprises an optical imaging assembly with at least two FOVs. One of the FOVs is adequate to acquire information from decodable indicia with higher density than other decodable indicia.

### TECHNICAL FIELD OF THE DISCLOSURE

The subject matter of the present disclosure relates to optical based registers, and particularly, to image sensor based indicia reading terminals.

### DISCUSSION OF RELATED ART

Indicia reading terminals and scanners (collectively, “terminals”) are available in multiple varieties. These terminals read and decode information encoded in decodable or information bearing indicia. Such decodable indicia are utilized generously, from encoding shipping and tracking information for packages, patient identification in hospitals, retail applications, and use on any number of forms and documents including, but not limited to, tax forms, order forms, transaction forms, survey forms, delivery forms, prescriptions, receipts, newspapers, product documents, reports, and the like.

### SUMMARY

Improvements in terminals are needed such as, for example, there is a need for a terminal with improved decoding of high density decodable indicia.

Terminals of the present disclosure incorporate lens elements that have a non-uniform magnification. This feature allows decoding of decodable indicia that exhibit different characteristics. These characteristics may affect the ability of the terminal to identify and decode the information stored therein. In one embodiment, the terminal comprises a lens element with at least two different levels of magnification. One of the levels of magnification is adequate to acquire information from decodable indica with higher density than other decodable indicia.

### BRIEF DESCRIPTION OF THE DRAWINGS

So that the manner in which the above recited features of the present invention can be understood in detail, a more particular description of the invention briefly summarized above, may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Moreover, the drawings are not necessarily to scale, emphasis generally being placed upon illustrating the principles of certain embodiments of invention.

Thus, for further understanding of the concepts of the invention, reference can be made to the following detailed description, read in connection with the drawings in which:

FIG. 1 depicts a schematic diagram of an exemplary embodiment of an indicia reading terminal;

FIG. 2 depicts a plot of a magnification curve for use with a lens element of an indicia reading terminal such as the indicia reading terminal of FIG. 1;

FIG. 3 depicts a schematic diagram of an example of an image sensor for use in an indicia reading terminal such as the indicia reading terminal of FIG. 1;

FIG. 4 depicts a perspective, exploded assembly view an example of an imaging module for use in an indicia reading terminal such as the indicia reading terminal of FIG. 1;

FIG. 5 depicts a perspective, assembled view of the imaging module of FIG. 4;

FIG. 6 depicts a perspective physical form view of an indicia reading terminal;

FIG. 7 depicts a schematic diagram of a hardware platform for use in an indicia reading terminal such as the indicia reading terminals of FIG. 1;

FIG. 8 depicts a flow diagram of a method of operating an indicia reading terminal such as the indicia reading terminal of FIG. 1; and

FIG. 9 depicts a flow diagram of another method of operating an indicia reading terminal such as the indicia reading terminals of FIGS. 1 and 6.

Where applicable like numerals identify like components amount the various views.

### DETAILED DESCRIPTION

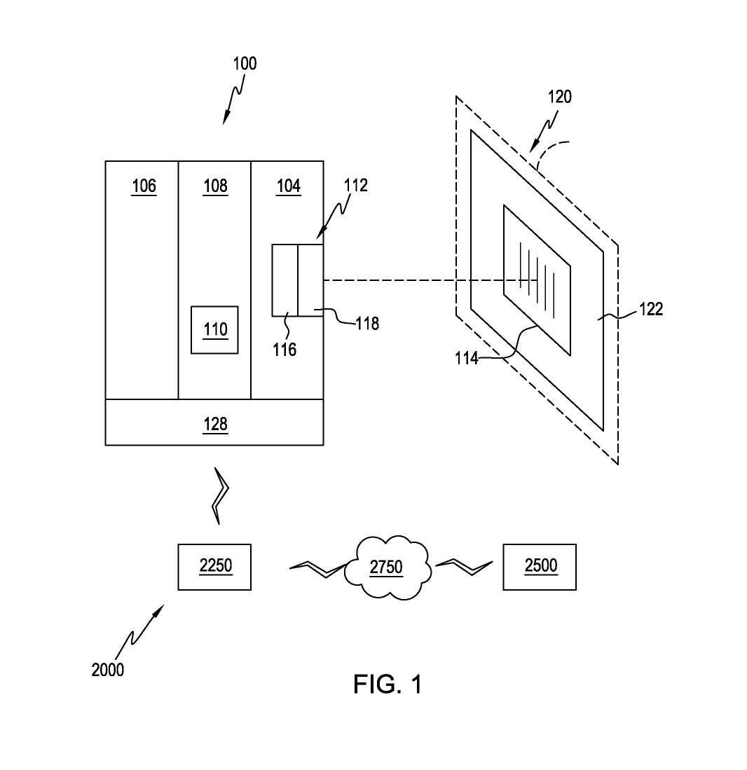

FIG. 1 illustrates an exemplary embodiment of a terminal 100 in schematic form. The terminal 100 may be any device capable of reading information bearing indicia, or decodable indicia, or more generally bar codes which bear information and data encoded therein. The terminal 100 can comprise a device structure 102 with a decoding module 104, a processing module 106 such as a central processing unit (“CPU”), and a storage module 108 such as memory that has at least one zone 110, e.g., for storing executable instructions that define various settings, configurations, and operating modes for the terminal 100.

At a relatively high level, embodiments of the terminal 100 read and decode decodable indicia of varying densities. These embodiments utilize non-uniform magnification of an image of a decodable indicia to improve process time and overall terminal performance. For example, non-uniform magnification can facilitate decoding of decodable indicia of different relative densities without the need to physically alter the relative location of the terminal 100 relative to the decodable indicia. In one aspect terminal 100 can correct for image distribution resulting from non-uniform magnification. Moreover, the inventors contemplate configurations of the terminal 100 that identify the presence of decodable indicia of higher relative density, thereby focusing processing of the information that the terminal collects at the information to which the high-density decodable indicia directly relates. The discussion below highlights features of these embodiments that implement such features.

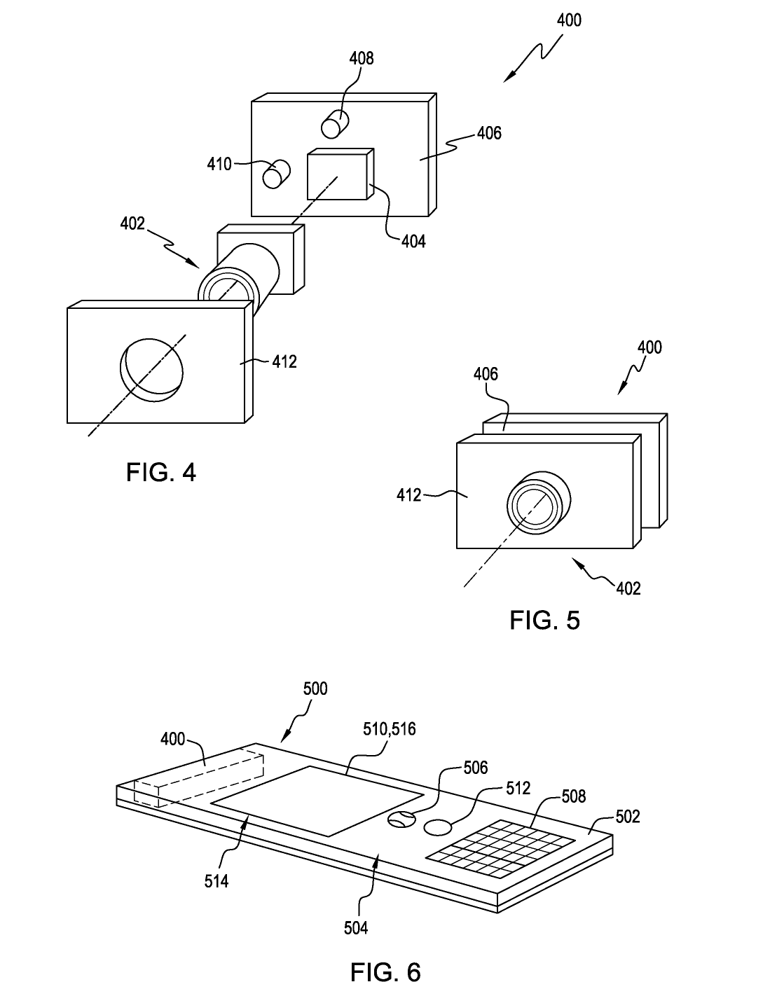

For example, FIG. 1 shows that the decoding module 104 can comprise a data capture device 112 to capture information encoded in decodable indicia 114. The data capture device 112 can have elements and features consistent with optical readers that have an imaging module (see, e.g., the imaging module 400 (FIGS. 4 and 5)). The imaging module can capture an image of the decodable indicia 114. In the present example, the imaging module comprises an image sensor 116 and a lens element 118 through which light that reflects from the decodable indicia 114 passes to the image sensor 116. The lens element 118 is configured to magnify an image of an indicia from an imaging area 120.

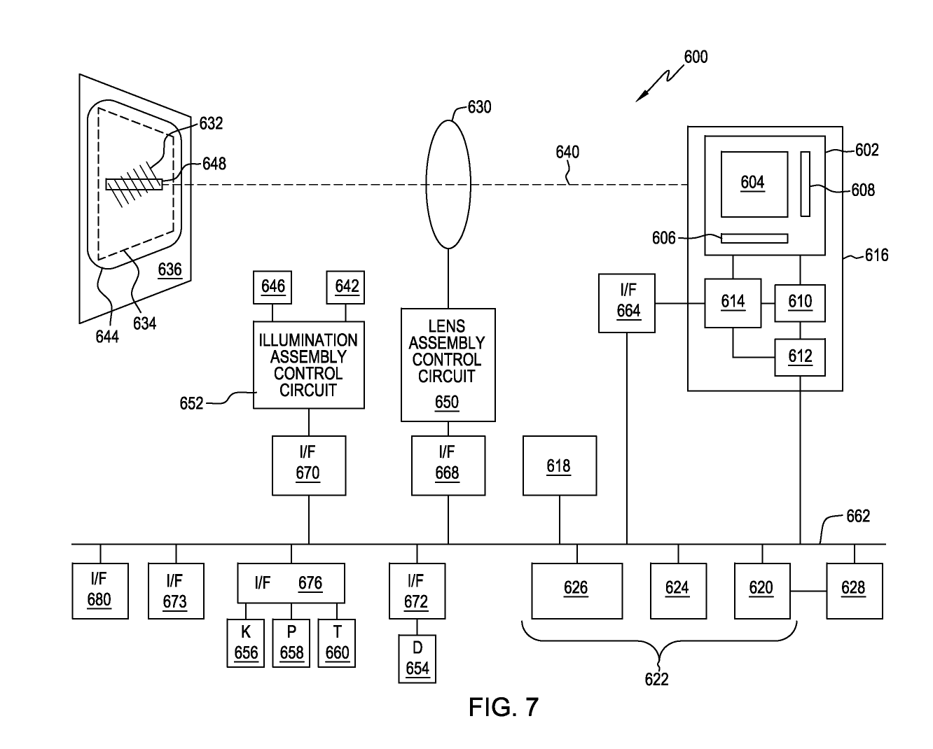

The terminal 100 also comprises an actuation device 128. This feature permits operation of the terminal 100 by an end user (not shown). For example, actuation of the actuation device 128 initiates decoding of information stored in the decodable indicia 114 such as by capturing an image that corresponds to the imaging area 120. There are of course other components and hardware that facilitate capturing and decoding of the decodable indicia 114, some of which are discussed in more detail in connection with the optical reader illustrated in FIGS. 4-6 and the hardware platform illustrated in FIG. 7 described below.

In one embodiment, the terminal 100 can be part of a system 2000. Here the system 2000 has a local server 2250, a remote server 2500, and a network 2750 that couples the local server 2250 and the remote server 2550. This configuration of the system 2000 can process the captured image data, and in one configuration one or more of the local server 2250 and the remote server 2550 entirely process the captured image data and operate the terminal 100 in a manner consistent with the disclosure below. In one embodiment, one or more of the processing module 106 and the storage module 108, or complementary ones thereof, can be located outside of the terminal 100. This configuration permits data and information captured by the terminal 100 to be transferred from the terminal 100, e.g., to a corresponding external storage module 108 for immediate and/or further processing of the captured image data. In another embodiment, image processing steps and other processes can be distributed as between the terminal 100, the local server 2250, and the remote server 2550, with still other embodiments being configured for the image processing and other processes to be executed entirely by the terminal 100.

The lens element 118 can comprise optics that receives light that reflects from decodable indicia 114 and focuses the reflected light onto the image sensor 116. “Optics” as the term is used herein can include configurations of the lens element 118 with a single optical component (or element), e.g., a single lens. The inventors also understand, however, that the lens element 118 can combine multiple types of optical components for the features and function that the present disclosure contemplates. Exemplary optical components can include lenses that comprise glass and suitable composites, as well varying layers of materials in the form of, e.g., optical coatings.

The lens element 118 exhibits certain non-uniform magnification properties that facilitate decoding of decodable indicia 114. These properties may apply across the lens element 118 such as where the magnification provided by the lens element 118 is highest at the center of a field of view (FOV) and decreases outward toward the periphery of the field of view.

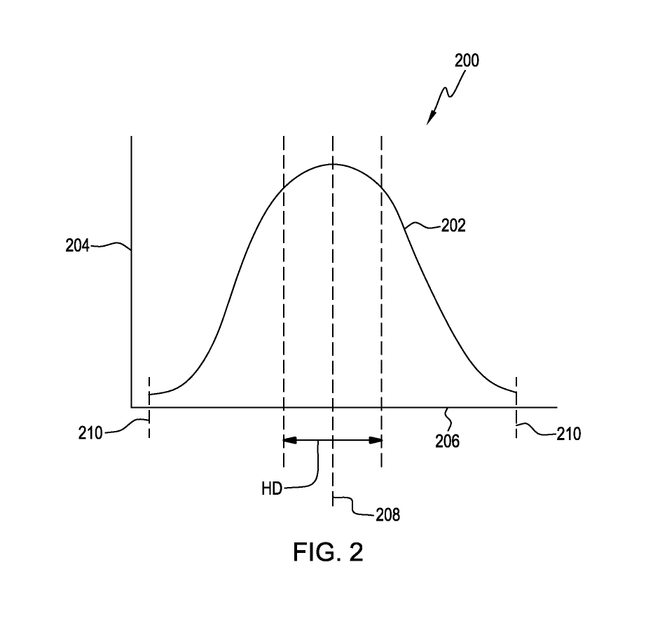

FIG. 2 depicts a plot 200 that describes one exemplary variation in the magnification of a lens element (e.g., lens element 118). The plot 200 includes a magnification curve 202 that defines the level of magnification (as measured on axis 204) over the field of view (FOV) of the lens element (as measured on axis 206). Also shown in FIG. 2 is the center axis 208 of the FOV and the peripheral edge 210. The inventors note, however, that while shown only in one dimension, the magnification curve 202 can apply across the two dimensions of the field of view of the lens system.

As FIG. 2 illustrates, the level of magnification is greatest at the center axis 208 of the lens element and decreases moving away from the center along the magnification curve 202 and out towards the peripheral edge 210. The decrease in the level of magnification can be gradual, such as when the magnification curve 202 forms a parabolic or otherwise non-linear shape.

In the present example, the level of magnification permits decoding of decodable indicia of higher density relative to other decodable indicia. Specifically, by increasing a magnification of an indicia, a captured frame of image data can comprise greater resolution (each pixel position of an image representing a smaller portion of an indicia than would be the result without the increased magnification) thereby increasing a likelihood of decoding, even for higher density decodable indicia. Although gradually decreasing, the inventors contemplate that certain areas of the FOV have a level of magnification that is sufficient for decoding of high-density decodable indicia. These areas can vary in dimensions. The example of FIG. 2 shows a high density area, demarcated by “HD,” where the level of magnification is suited for high density decodable indicia. Outside of the area HD, the level of magnification is sufficient for decodable indicia such as those decodable indicia that require a lower level of magnification relative to the high density decodable indicia.

With continued reference to FIGS. 1 and 2, symbology, coding, and other aspects of the decodable indicia (e.g., the decodable indicia 114) may be selected in accordance with configuration and capabilities of the processing module 106. In one embodiment, the processing module 106 can be any type of CPU or microprocessor with exemplary functions designed to decode machine readable types of symbology, and particularly in connection with symbology found in the captured document image data. Decoding is a term used to describe the successful interpretation of machine readable indicia contained in an image captured by the data capture device 112.

The code has data or information encoded therein. Information respecting various reference decode algorithms are available from various published standards, such as by the International Standards Organization (“ISO”). Examples may comprise one dimensional (or linear) symbologies, stacked symbologies, matrix symbologies, composite symbologies, or other machine readable indicia. One dimensional (or linear) symbologies which may include very large to ultra-small, Code 128, Interleaved 2 of 5, Codabar, Code 93, Code 11, Code 39, UPC, EAN, MSI, or other linear symbologies. Stacked symbologies may include PDF, Code 16K, Code 49 or other stacked symbologies. Matrix symbologies may include Aztec, Datamatrix, Maxicode, QR Code or other 2D symbologies. Composite symbologies may include linear symbologies combined with stacked symbologies. Other symbology examples may comprise OCR-A, OCR-B, MICR types of symbologies. UPC/EAN symbology or barcodes are standardly used to mark retail products throughout North America, Europe and several other countries throughout the world.

A number of decodable indicia consist of a series or a pattern of light and dark areas of varying widths. In common 1D decodable indicia, the dark areas may comprise elongated parallel “bars” separated by light areas or “spaces.” Certain 2D decodable indicia may encode information in, e.g., a checkerboard pattern. The arrangement of the dark areas and light areas define the information encoded in the resulting decodable indicia. For decodable indicia considered to be high density, the relative size, spacing, and other characteristics of the dark areas and the light areas may be smaller and more tightly defined. Decoding of high density decodable indicia therefore often requires that the image data the terminal 100 gathers is of higher quality than decodable indicia of relatively lower density.

The relative quality may determine the characteristics (e.g., size and shape) of the area HD and/or the shape of the magnification curve 202. As FIG. 2 shows, in one embodiment, the area HD covers only a portion of the FOV. The area HD is indicative of the field of view for use to capture and decode image data of the high-density decodable indicia. On the other hand, the area outside of the area HD permits capture of image data indicative of and more suited to low-density decodable indicia (e.g., relative to the high-density decodable indicia).

The image sensor 116 is sensitive to light that passes through the lens element and onto the surface of the image sensor 116. Generally the image sensor 116 comprises a pixel array that has pixels arranged in rows and columns of pixels. The pixels generate signals from which image information is resolved by, e.g., the decoding module 104 and/or the processing module 106. As discussed above, the lens element directs light that reflects from the decodable indicia onto the image sensor 116.

Embodiments of the terminal 100 can correct for image distortion resulting from use of lens element 118 having magnification curve 202. In one embodiment, the terminal 100 deals with image distortion with a distortion correction. The distortion correction has one or more known or discernable values. These values can be programmed, such as in software or firmware, hardwired during manufacturing, and also implemented via user-selected configurations. The value of the distortion correction may be based on the manufacture and design of the lens element. In one example, the value reflects the variable magnification of the lens element that the magnification curve 202 describes and the present disclosure sets forth above. In other examples, the terminal 100 calculates the value according to an algorithm or other set of executable instructions that are stored in, e.g., the storage module 108.

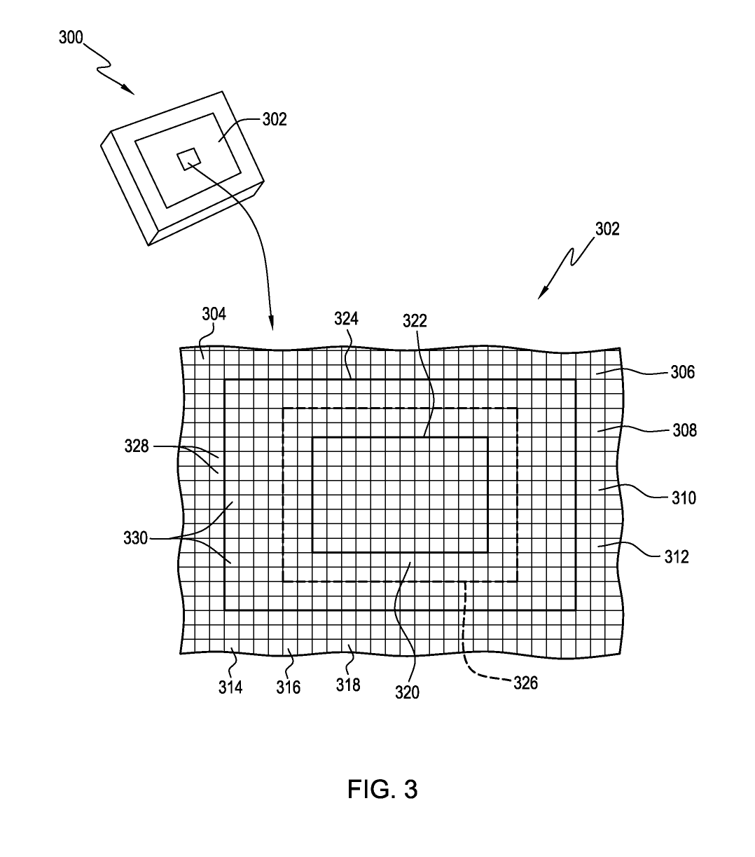

FIG. 3 illustrates an example of an image sensor 300 (e.g., the image sensor 116). The image sensor can comprise color or monochrome 1D or 2D charge coupled devices (“CCD”), semiconductor devices (e.g., CMOS, NMOS, and PMOS), and other solid state image sensors with properties and characteristics useful for capturing and processing image data, such as image data of a decodable indicia. In FIG. 3 the image sensor 300 comprises an image sensor pixel array 302 (or “pixel array 302”). The pixel array 302 can include pixels 304 in one or more rows 306 (e.g., rows 308, 310, 312) and one or more columns 314 (e.g., columns 316, 318, 320). Superimposed on the pixel array 302 are a first area 322 and a second area 324, which exhibit different levels of magnification as the curve 202 of FIG. 2 defines.

FIG. 3 also shows an image capture area 326. The image capture area 326 covers an area of the pixel array 302 and defines, in one example, a number of the pixels 304 that are subject to processing as defined herein. The size of the image capture area 326 can change as necessary to focus the processing of particular areas of the pixel array 302. In one embodiment, the image capture area 326 covers sufficient number of pixels 304 to gather image data that corresponds to the first area 322 that, in other words, corresponds to the area where the level(s) of magnification are conducive to decoding of high-density decodable indicia. Expanding and/or contracting the size of the image capture area 326 will cover more or less number of the pixel area 302. In one example, the image capture frame 326 covers each of the first area 322 and the second area 324. In another example, the image capture area 326 covers only a portion of the first area 322.

Use of the image capture area 326 permits a terminal (e.g., terminal 100) to focus directly on, e.g., decoding a high density decodable indicia or, in one example, determining whether there is a high density decodable indicia present in the image area (e.g., image area 120). For example, if the image capture area 326 only covers the first area 322 (or a portion thereof), then the terminal can first process the captured image data that corresponds only to the portion of the optics that exhibit higher levels of magnification relative to other portions of the optics. The higher prescribed levels of magnification may more likely lead to successful decoding of the decodable indicia in the first area 322, particularly if the decodable indicia exhibits higher density or other properties that may make reading and decoding more difficult.

In one embodiment, the terminal can associate the configurations of the image capture area 326 with the prescribed levels of magnification of the optics. That is, the terminal can size the image capture area 326 to accommodate the relative dimensions, positions, and other features of the optics such as the portions of the optics that are ascribed the varying prescribed levels of magnification according with the magnification curve 202 of FIG. 2. Again, in one example, these features may be pre-programmed in the terminal, so that in operation the terminal is automatically configured to identify the features of the optics. In other example, the terminal may learn or obtain the features and variations of magnification (e.g., the shape of the magnification curve) through use, calibration procedures, or other methods that permit the terminal to accommodate for differences in the variable and different levels of magnification of the optics. In one embodiment, this association is made by way of, e.g., the response of the pixels 304 that indicate where the decodable indicia is positioned relative to the image area (e.g., image area 120), the various fields of view associated with the optics, and/or the areas of the pixel array 302 such as the first area 322 and the second area 324.

In other embodiments, a succession of frames of image data that can be captured and subject to the described processing can be full frames (including pixel values corresponding to each pixel of the pixel array 302 or a maximum number of pixels read out from the pixel array 302 during operation of the terminal). A succession of frames of image data that can be captured and subject to the described processing can also be “windowed frames” comprising pixel values corresponding to less than a full frame of pixels of the pixel array 302. A succession of frames of image data that can be captured and subject to the described processing can also comprise a combination of full frames (e.g., the entirety of the pixel array 302) and windowed frames (e.g., one or more of the first area 322 and the second area 324). A full frame can be read out for capture by selectively addressing pixels of image sensor 300 having the pixel array 302 corresponding to the full frame. A windowed frame can be read out for capture by selectively addressing pixels of image sensor 300 having the pixel array 302 corresponding to the windowed frame. In one embodiment, a number of pixels subject to addressing and read out determine a picture size of a frame. Accordingly, a full frame can be regarded as having a first relatively larger picture size and a windowed frame can be regarded as having a relatively smaller picture size relative to a picture size of a full frame. A picture size of a windowed frame can vary depending on the number of pixels subject to addressing and readout for capture of a windowed frame.

Terminals of the present disclosure can capture frames of image data at a rate known as a frame rate. A typical frame rate is 60 frames per second (FPS) which translates to a frame time (frame period) of 16.6 ms. Another typical frame rate is 30 frames per second (FPS) which translates to a frame time (frame period) of 33.3 ms per frame. A frame rate of these terminals can be increased (and frame time decreased) by decreasing of a frame picture size.

Various configurations of the pixel array 302 are possible. For example, the pixel array 302 may be a hybrid monochrome and color array, which can include a first subset of monochrome pixels 328 devoid of color filter elements and a second subset of color pixels 330 including color filter elements. The majority of pixels of the image sensor array can be monochrome pixels of the first subset. Color sensitive pixels of the second subset are at spaced apart positions and can be uniformly or substantially uniformly distributed throughout the image sensor array. The color sensitive pixels can be spaced apart in positions of the pixel array 302 and can be disposed at positions uniformly or substantially uniformly throughout the pixel array 302. Color sensitive pixels may be distributed in the array in a specific pattern of uniform distribution such as a period of P=4 where, for every fourth row of pixels of the array, every fourth pixel is a color sensitive pixel as shown in FIG. 3. Alternatively, other distributions may be used such as a period of P=2, where every other pixel of every other row of the image sensor array is a color sensitive pixel.

In one embodiment, the spaced apart color pixels of the image sensor 200 can follow a pattern according to a Bayer pattern. As FIG. 3 shows, where Red=R, Green=G, and Blue=B, the color pixels in row 306 can have the pattern . . . GRGRGRG . . . which repeats for rows 310 and 314. The pixels of row 308 can have the pattern . . . BGBGBGB . . . , which pattern can be repeated for row 312. The patterns in rows 306, 312, 310, 314, 308 can repeat throughout color image sensor pixel array 300. Alternatively, different patterns for the color pixels may be used. A color frame of image data captured with use of a pixel array 302 having both color and monochrome pixels can include monochrome pixel image data and color pixel image data. The image sensor 300 can be packaged in an image sensor integrated circuit. Various additional features that can be utilized with terminals the inventors contemplated herein (e.g., terminal 100 (FIG. 1)) are disclosed in U.S. patent application No. 11/174,447 entitled, Digital Picture Taking Optical Reader Having Hybrid Monochrome And Color Image Sensor Array, filed Jun. 30, 2005, incorporated herein by reference.

FIGS. 4, 5 and 6 illustrate an example of an imaging module 400 for use in a terminal as set forth herein, e.g., terminal 100 as shown in FIG. 1, and terminal 500 as set forth in FIG. 6. In one embodiment, the imaging module 400 can comprise a lens element 402 (e.g., lens element 118) and an image sensor 404 that is disposed on a printed circuit board 406. Also found on the printed circuit board 406 is an illumination pattern light source bank 408 (“the illumination bank 408”) and aiming pattern light source bank 410 (“the aiming bank 410”). Here, each of the illumination bank 408 and the aiming bank 410 comprise a single light source. The imaging module 400 can also include an optical plate 410 that has optics for shaping light from illumination bank 408 and the aiming bank 412 into predetermined patterns.

The aiming bank 410 can comprise various devices. These devices generate light beams, and in one example, the light beams are in the form of laser light and/or light of sufficient coherence to project long-distances outward from the imaging module 400. For one embodiment, the aiming bank 410 emits light that can impinge on objects at a distance of least about 5 m away. The light may facilitate alignment of the optics in the optical imaging assembly 402 with the target decodable indicia. In particular, focused light of, e.g., the laser, may facilitate alignment of the portions of the optics with the higher magnification (e.g., higher relative prescribed levels of magnification). In one example, configuration of the imaging module 400 associates the position of the aiming bank 410 with the position (and optical properties) of the optics in the optical imaging assembly 402. This association position permits proper alignment of the optics with the decodable indicia when the end user directs the light that the aiming bank 410 generates onto the target decodable indicia. For example, positioning the light on the decodable indicia may ensure that the decodable indicia is in position with the portion of the FOV that provides higher or better magnification.

The imaging module 400 is found in terminals and registers such as the terminal 100 (FIG. 1) and the exemplary embodiment of a terminal 500 in FIG. 6. The terminal 500 can include a hand held housing 502 that supports a user input interface 504 with a pointer controller 506, a keyboard 508, a touch panel 510, and a trigger 512. The hand held housing 502 can also support a user output interface 514 with a display 516. Imaging module 1400 can be disposed in and can be supported by hand held housing 502.

Exemplary devices that can be used for devices of the user input interface 504 are generally discussed immediately below. Each of these is implemented as part of, and often integrated into the hand held housing 502 so as to permit an operator to input one or more operator initiated commands. These commands may specify, and/or activate certain functions of the indicia reading terminal. They may also initiate certain ones of the applications, drivers, and other executable instructions so as to cause the indicia reading terminal 500 to operate in an operating mode.

Devices that are used for the point controller 506 are generally configured so as to translate the operator initiated command into motion of a virtual pointer provided by a graphical user interface (“GUI”) of the operating system of the indicia reading terminal 500. It can include devices such as a thumbwheel, a roller ball, and a touch pad. In some other configurations, the devices may also include a mouse, or other auxiliary device that is connected to the indicia reading terminal 500 by way of, e.g., via wire or wireless communication technology.

Implementation of the keyboard 508 can be provided using one or more buttons, which are presented to the operator on the hand held housing 502. The touch panel 510 may supplement, or replace the buttons of the keyboard 508. For example, one of the GUIs of the operating system may be configured to provide one or more virtual icons for display on, e.g., the display 516, or as part of another display device on, or connected to the indicia reading terminal 500. Such virtual icons (e.g., buttons, and slide bars) are configured so that the operator can select them, e.g., by pressing or selecting the virtual icon with a stylus (not shown) or a finger (not shown).

The virtual icons can also be used to implement the trigger 512. On the other hand, other devices for use as the trigger 512 may be supported within, or as part of the hand held housing 502. These include, but are not limited to, a button, a switch, or a similar type of actionable hardware that can be incorporated into the embodiments of the indicia reading terminal 500. These can be used to activate one or more of the devices of the portable data terminal, such as the bar code reader discussed below.

Displays of the type suited for use on the indicia reading terminal 500 are generally configured to display images, data, and GUIs associated with the operating system and/or software (and related applications) of the indicia reading terminal 500. The displays can include, but are not limited to, LCD displays, plasma displays, LED displays, among many others and combinations thereof. Although preferred construction of the indicia reading terminal 500 will include devices that display data (e.g., images, and text) in color, the display that is selected for the display 516 may also display this data in monochrome (e.g., grayscale). It may also be desirable that the display 516 is configured to display the GUI, and in particular configurations of the indicia reading terminal 500 that display 516 may have an associated interactive overlay, like a touch screen overlay on touch panel 510. This permits the display 516 to be used as part the GUI so as to permit the operator to interact with the virtual icons, the buttons, and other implements of the GUI to initiate the operator initiated commands, e.g., by pressing on the display 516 and/or the touch panel 510 with the stylus (not shown) or finger (not shown).

The hand held housing 502 can be constructed so that it has a form, or “form factor” that can accommodate some, or all of the hardware and devices mentioned above, and discussed below. The form factor defines the overall configuration of the hand held housing 502. Suitable form factors that can be used for the hand held housing 502 include, but are not limited to, cell phones, mobile telephones, personal digital assistants (“PDA”), as well as other form factors that are sized and shaped to be held, cradled, and supported by the operator, e.g., in the operator's hand(s) as a gun-shaped device. One exemplary form factor is illustrated in the embodiment of the indicia reading terminal 500 that is illustrated in the present FIG. 6.

FIG. 7 illustrates another exemplary embodiment of a terminal 600 in schematic form. The terminal 600 can include an image sensor 602 comprising a multiple pixel image sensor array 604 (“the image sensor array”) having a plurality of pixels arranged in rows and columns of pixels, including column circuitry 606 and row circuitry 608. Associated with the image sensor 602 can be amplifier 610, and an analog to digital converter 612 which converts image information in the form of analog signals read out of image sensor array 604 into image information in the form of digital signals. Image sensor 602 can also have an associated timing and control circuit 614 for use in controlling, e.g., the exposure period of image sensor 602, and/or gain applied to the amplifier 610.

The noted circuit components 602, 610, 612, and 614 can be packaged into an image sensor integrated circuit 616. In one example, image sensor integrated circuit 616 can be provided by an MT9V022 image sensor integrated circuit available from Micron Technology, Inc. In another example, image sensor integrated circuit 616 can incorporate a Bayer pattern filter. In such an embodiment, CPU 618 prior to subjecting a frame to further processing can interpolate pixel values intermediate of green pixel values for development of a monochrome frame of image data. In other embodiments, red, and/or blue pixel values can be utilized for the monochrome image data.

In the course of operation of terminal 600 image signals can be read out of image sensor 602, converted and stored into a system memory such as RAM 620. A memory 622 of terminal 600 can include RAM 620, a nonvolatile memory such as EPROM 624, and a storage memory device 626 such as may be provided by a flash memory or a hard drive memory. In one embodiment, terminal 600 can include CPU 618 which can be adapted to read out image data stored in memory 622 and subject such image data to various image processing algorithms. Terminal 600 can include a direct memory access unit (DMA) 628 for routing image information read out from image sensor 602 that has been subject to conversion to RAM 620. In another embodiment, terminal 600 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 602 and RAM 620 are within the scope and the spirit of the invention.

Referring to further aspects of terminal 600, terminal 600 can include an imaging lens assembly 630 for focusing an image of a form barcode 632 located within a field of view 634 on a substrate 636 onto image sensor array 604. Imaging light rays can be transmitted about an optical axis 640. The imaging lens assembly 630 can be adapted to be capable of multiple focal lengths and/or multiple best focus distances.

Terminal 600 can also include an illumination pattern light source bank 642 for generating an illumination pattern 644 substantially corresponding to the field of view 634 of terminal 600, and an aiming pattern light source bank 646 for generating an aiming pattern 648 on substrate 636. In use, terminal 600 can be oriented by an operator with respect to a substrate 636 bearing the form barcode 632 in such manner that aiming pattern 648 is projected on the form barcode 632. In the example of FIG. 7, the form barcode 632 is provided by a 1D bar code symbol. Form barcode could also be provided by 2D bar code symbols, stacked linears, or optical character recognition (OCR) characters, etc.

Each of illumination pattern light source bank 642 and aiming pattern light source bank 646 can include one or more light sources. The imaging lens assembly 630 can be controlled with use of lens assembly control circuit 650 and the illumination assembly comprising illumination pattern light source bank 642 and aiming pattern light source bank 646 can be controlled with use of illumination assembly control circuit 652. Lens assembly control circuit 650 can send signals to the imaging lens assembly 630, e.g., for changing a focal length and/or a best focus distance of imaging lens assembly 630. This can include for example providing a signal to the piezoelectric actuator to change the position of the variable position element of the focus element discussed above. Illumination assembly control circuit 652 can send signals to illumination pattern light source bank 642, e.g., for changing a level of illumination output by illumination pattern light source bank 642.

Terminal 600 can also include a number of peripheral devices such as display 654 for displaying such information as image frames captured with use of terminal 600, keyboard 656, pointing device 658, and trigger 660 which may be used to make active signals for activating frame readout and/or certain decoding processes. Terminal 600 can be adapted so that activation of trigger 660 activates one such signal and initiates a decode attempt of the form barcode 632.

Terminal 600 can include various interface circuits for coupling several of the peripheral devices to system address/data bus (system bus) 662, for communication with CPU 618 also coupled to system bus 662. Terminal 600 can include interface circuit 664 for coupling image sensor timing and control circuit 614 to system bus 662, interface circuit 668 for coupling the lens assembly control circuit 650 to system bus 662, interface circuit 670 for coupling the illumination assembly control circuit 652 to system bus 662, interface circuit 672 for coupling the display 654 to system bus 662, and interface circuit 676 for coupling the keyboard 656, pointing device 658, and trigger 660 to system bus 662.

In a further aspect, terminal 600 can include one or more I/O interfaces 673, 680 for providing communication with external devices (e.g., a cash register server, a store server, an inventory facility server, a peer terminal, a local area network base station, a cellular base station, etc.). I/O interfaces 673, 680 can be interfaces of any combination of known computer interfaces, e.g., Ethernet (IEEE 802.3), USB, IEEE 802.11, Bluetooth, CDMA, GSM, IEEE 1394, RS232 or any other computer interface.

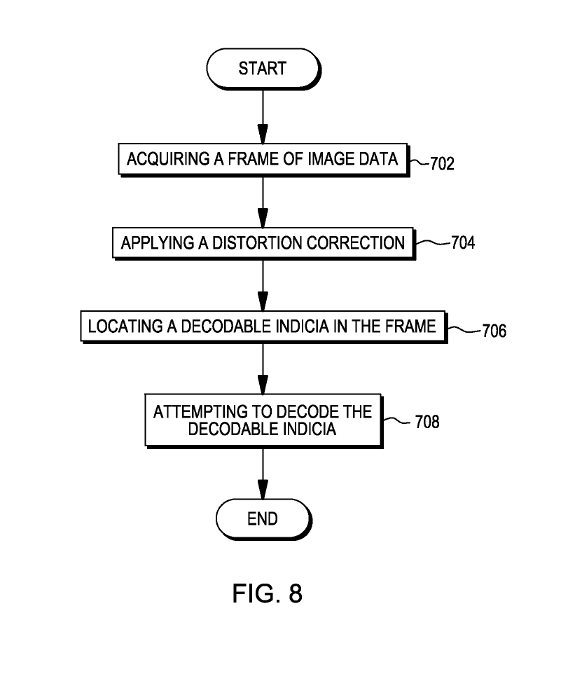

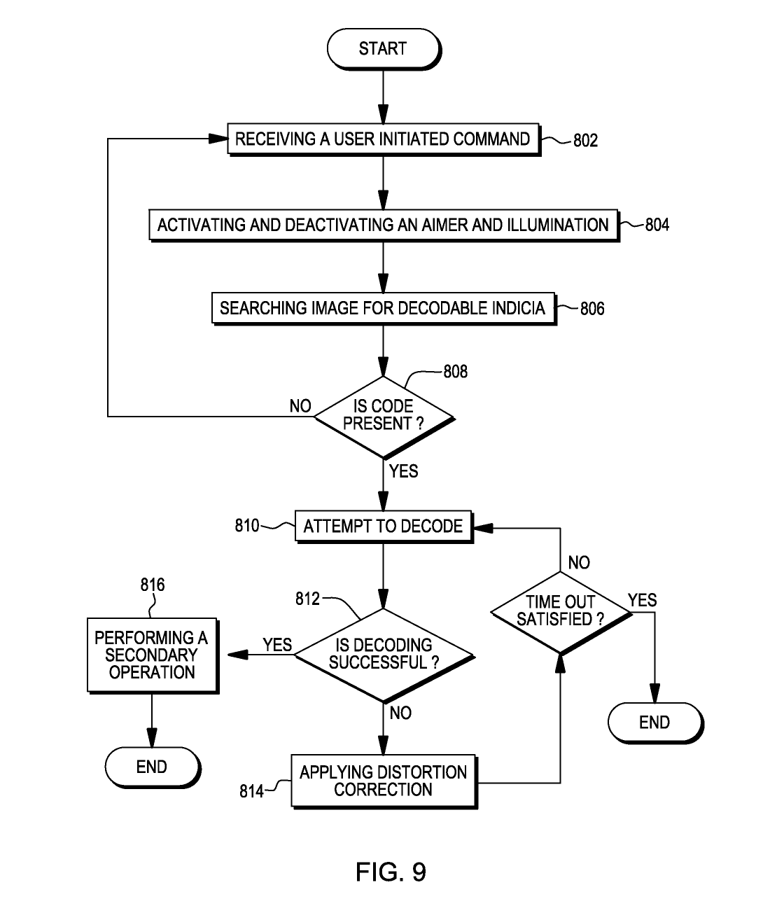

Referring now to FIGS. 8 and 9, the disclosure presents various methods of operation of terminals constructed in accordance herewith. At a relatively high level, the methods outline steps for capturing and decoding image data from decodable indicia. Implementation of these methods (or particular combinations of the steps) may improve processing times such as by focusing first on objects in the fields of view that result from the higher magnification configurations of the optics.

FIG. 8 depicts blocks of an exemplary embodiment of a method 700. The method 700 comprises, at block 702, acquiring a frame of image data, at block 704, applying a distortion correction, at block 706, locating a decodable indicia in the frame and, at block 708, attempting to decode the decodable indicia. Collectively the blocks of method 700 effectuate decoding of the information embedded in decodable indicia. As discussed previously, the distortion correction corrects for image distortion due to the varying and/or variable magnification of the optic.

Another exemplary embodiment of a method 800 is found in FIG. 9. Like numerals are used to identify like blocks as between FIG. 8 and FIG. 9, except that the numerals in FIG. 9 are increased by 100. For example, the method 800 comprises, at block 802, receiving a user initiated command, at block 804, activating and deactivating an aimer and illumination and, at block 806, searching for decodable indicia. The method 800 can also comprise, at block 808, determining whether a decodable indicia is present and if such decodable indicia is found, the method 800 continues, at block, 810, attempting to decode the decodable indicia. On the other hand, if such decodable indicia is not present, then the method 800 may enter a condition in which the terminal waits for another user initiated command (at block 802).

The method 800 can also comprise, at block 812, determining whether the decoding of the decodable indicia was successful. If the decode is not successful, the method 800 may continue, at block, 814, applying a distortion correction and thereafter, at block 810 (if a timeout is not satisfied at block 815) attempting to decode again. On the other hand, if the decode is successful, the method 800 may continue, at block 816, performing a secondary operation, which may include additional processing steps, data transmission steps, and/or other steps that are consistent with exemplary terminals and devices the present disclosure describes.

The search for the decodable indicia can include, in one example, highest prioritized search for decodable indicia in an area of a captured frame corresponding to the area of greatest magnification, e.g., a center of a frame image data. As the disclosure explains above, this area often corresponds to the position where data respecting high-density decodable indicia is found. Thus, in one embodiment, processing of data improves because the processing can be prioritized to initially identify and decode representations of decodable indicia of a certain region, e.g., a center of a frame of image data. Windowing and other techniques to interrogate the pixels of the image sensor may help to determine if there the decodable indicia is present. When the decodable indicia is not located during this initial step, however, the terminal can continue with windowing or selective processing of pixels and/or areas of the pixel array. For example, the terminal can change the location and/or position of the window, process the data corresponding to those windowed pixels, and so on. These techniques can save valuable processing time. That is, rather than processing all of the data associated with all of the pixels of the pixel array, windowing processes a fraction or finite set of data at one or more locations corresponding to the pixel array.

In view of the foregoing, terminals of the present disclosure have variable and/or non-uniform magnification. The difference in magnification may correspond to different prescribed levels of magnification such as according to a known curve (e.g., curve 202) or other known manner. The prescribed levels accommodate for high density decodable indicia and other types of symbology that may be difficult to image and process. The terminal is operative to address image distortion that may exist as a result of the variable magnification designed into the lens system.

Where applicable it is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. An indicia reading terminal, comprising:
a two dimensional image sensor comprising a plurality of pixels extending along an image plane, an optical imaging assembly for use in focusing imaging light rays onto the plurality of pixels of said two dimensional image sensor, and a housing encapsulating the two dimensional image sensor array and the optical imaging assembly,
wherein the optical imaging assembly comprises a lens element having a non-uniform magnification defined by a magnification curve that describes a prescribed level of magnification of the lens element, and
wherein said terminal is operative to apply a distortion correction that corresponds to the magnification curve.

2. The indicia reading terminal of claim 1, wherein the magnification curve is characterized by being generally greater at a central region thereof relation to edge regions of the magnification curve.

3. An indicia reading terminal according to claim 1, wherein the lens element has a first prescribed level of magnification proximate the center of the field of view and a second prescribed level of magnification in surrounding relation to the first prescribed level, and wherein the first prescribed level is greater than the second prescribed level.

4. An indicia reading terminal according to claim 1, wherein the magnification curve has a parabolic shape with a peak at a center of the lens element.

5. An indicia reading terminal according to claim 1, wherein the terminal is operative to capture a frame of image data, in response to a user initiated command, and to process the frame of image data for attempting to decode a barcode.

6. An indicia reading terminal according to claim 1, further comprising an aiming bank, wherein the aiming bank is configured to generate a beam of light

7. An indicia reading terminal according to claim 6, wherein the aiming bank is positioned with respect to the optics so the coherent beam of light acts to align a portion of the magnification curve with the with a decodable indicia disposed on a target.

8. An indicia reading terminal according to claim 6, wherein the aiming bank comprises a laser.

9. An indicia reading terminal according to claim 1, wherein the terminal is operative to calculate the distortion correction.

10. A system for imaging decodable indicia on a target, said system comprising:
an indicia reading terminal comprising a data capture device, the data capture device comprising a pixel array and optics through which passes light reflected from the decodable indicia, and a housing encapsulating the data capture device;
an external server in communication with the indicia reading terminal, the external server external to the indicia reading terminal;
wherein the system is operative, in response to an operator initiated command, to capture a frame of image data and processes the frame of image data for attempting to decode the decodable indicia,
wherein the optics conform to a magnification curve that defines a varying level of magnification for the optics, and
wherein the varying levels of magnification comprise a relatively high level of magnification that corresponds to a center portion of the field of view and a relatively low level of magnification that corresponds to a portion of the field of view about the periphery, and
wherein the terminal is operative to process the frame to accommodate for differences in the high level and the low level.

11. A system according to claim 11, wherein the terminal is operative to accommodate for image distortion.

12. A system according to claim 11, wherein the high level has a value suited to image a high density decodable indicia.

13. A system according to claim 11, wherein the terminal is operative to process a windowed frame, and wherein the windowed frame is read out for capture by selectively addressing pixels corresponding to a portion of the pixel array.

14. A system according to claim 11, wherein the processing of the image data occurs on the external server.

15. A method of decoding a decodable indicia, said method comprising:
acquiring a frame of image data using optics having a magnification curve defining a varying level of magnificiation;
applying a distortion correction to the image data;
locating a decodable indicia in the frame; and
attempting to decode the decodable indicia.

16. A method according to claim 16, further comprising searching data that corresponds to a first area of pixels on an image sensor for decodable indicia, wherein the first area corresponds to a level of magnification that is suitable for high-density decodable indicia.

17. A method according to claim 17, wherein the first area corresponds to one of a plurality of fields of view in which the decodable indicia is found.

18. A method according to claim 16, further comprising identifying the quality of the decodable indicia.

19. A method according to claim 16, further comprising activating and deactivating an aimer and illumination.
